(19) United States
(12) Patent Application Publication
(10) Pub. No.: US 2003/0128091 A1
(43) Pub. Date: Jul. 10, 2003

(54) Transformer

(76) Inventor: Albert Sullivan, Gary, IN (US)

Correspondence Address: ALBERT SULLIVAN, 2101 WEST 19TH AVENUE, GARY, IN, 46404, US

(21) Appl. No.: 10/040,356

(22) Filed: Jan. 7, 2002

(51) Int. Cl. H01F 27/28

(52) U.S. Cl. 336/182

(57) ABSTRACT

This invention utilizes hollow core construction to remediate heat saturation that causes inefficient power transmission.

### CROSS REFERENCE TO RELATED APPLICATIONS

None

### STATEMENT REGARDING FEDERALLY SPONSORED RESEARCH OR DEVELOPEMENT

No govermental assistance was utilized.

### REFERENCE TO A MICROFICHE APPENDIX

None

### BACKGROUND OF THE INVENTION

Field of invention, energy. Problems with prior art are poor heat transfer and poor current transfer.

### BRIEF SUMMARY OF THE INVENTION

This invention has improved thermal properties, better current transfer and improved energy efficiency.

### BRIEF DESCRIPTION OF THE SEVERAL VIEWS OF THE DRAWING

None

### DETAILED DESCRIPTION OF THE INVENTION

Current and older versions use either wafer type or solid material type construction. My invention utilizes a hollow core.

1. What I claim as my invention is any hollow composite core electromagnet used to produce induced power.
